(19) United States
(12) Patent Application Publication
(10) Pub. No.: US 2022/0391045 A1
(43) Pub. Date: Dec. 8, 2022

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Daiki MATSUOKA, Kanagawa (JP)

(73) Assignee: FUJIFILM Business Innovation Corp., Tokyo (JP)

(21) Appl. No.: 17/542,476

(22) Filed: Dec. 5, 2021

(30) Foreign Application Priority Data
Jun. 8, 2021 (JP) 2021-095569

(51) Int. Cl. G06F 3/0481; G06F 3/0486; G06F 3/04842; G06F 16/22

(52) U.S. Cl. CPC G06F 3/0481; G06F 3/0486; G06F 3/04842; G06F 16/22

(57) ABSTRACT

An information processing apparatus includes a processor configured to select at least one of a user-associated operator that is an operator for inputting an instruction related to target data and is associated with a user, or a task step-associated operator that is an operator for inputting the instruction related to the target data and is associated with a task step related to a task performed by one or plural users, based on an operator database storing the user-associated operator and the task step-associated operator and display the selected operator on a display screen.

### CROSS-REFERENCE TO RELATED APPLICATIONS

This application is based on and claims priority under 35 USC 119 from Japanese Patent Application No. 2021-095569 filed Jun. 8, 2021.

### BACKGROUND

### (i) Technical Field

The present invention relates to an information processing apparatus, a non-transitory computer readable medium storing an information processing program, and an information processing method.

### (ii) Related Art

In the related art, in a case of performing a task for target data on a display screen, an instruction related to the target data has been input by operating an operator displayed on the display screen. In addition, in the related art, a technology for enabling the operator displayed on the display screen to be changed has been suggested.

For example, JP2016-51427A discloses an information processing apparatus that can customize an operator displayed on a display screen and causes a user to select an operator to be displayed on the display screen from operators corresponding to a current editing mode of an application for editing target data. In addition, JP2005-284559A discloses an information processing apparatus that can switch an operator to be displayed on a display screen in accordance with an operation mode of the apparatus.

### SUMMARY

One or a plurality of users may perform the task for the target data on the display screen in a plurality of task steps. In this case, preparation of a user-associated operator associated with the users and a task step-associated operator associated with the task steps is considered.

Aspects of non-limiting embodiments of the present disclosure relate to an information processing apparatus, a non-transitory computer readable medium storing an information processing program, and an information processing method that enable a selected one of a user-associated operator or a task step-associated operator to be used in a case where one or a plurality of users perform a task for target data on a display screen in a plurality of task steps.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to select at least one of a user-associated operator that is an operator for inputting an instruction related to target data and is associated with a user, or a task step-associated operator that is an operator for inputting the instruction related to the target data and is associated with a task step related to a task performed by one or a plurality of users, based on an operator database storing the user-associated operator and the task step-associated operator and display the selected operator on a display screen.

### BRIEF DESCRIPTION OF THE DRAWINGS

Exemplary embodiment(s) of the present invention will be described in detail based on the following figures, wherein:

FIG. 1 is a schematic configuration diagram of an information processing system according to an exemplary embodiment;

FIG. 2 is a schematic configuration diagram of a user terminal;

FIG. 3 is a schematic configuration diagram of a document management server;

FIG. 4 is a diagram illustrating an example of a display screen of a document management application;

FIG. 5 is a conceptual diagram illustrating a content of a registration DB;

FIG. 6 is a conceptual diagram illustrating a content of a history DB;

FIG. 7 is a diagram illustrating a title of each customized button;

FIG. 8 is a diagram illustrating a display example of a user-associated button;

FIG. 9 is a diagram illustrating a display example of a switching button;

FIG. 10 is a diagram illustrating a display example of a document-associated button;

FIG. 11 is a diagram illustrating a display example of a modification example of the user-associated button and the switching button;

FIG. 12 is a diagram illustrating an example of a button switching window;

FIG. 13 is a diagram illustrating a display example in which a user-associated history button and a document-associated history button are displayed at the same time;

FIG. 14 is a diagram illustrating a state of an operation of registering a history button as a registration button; and

FIG. 15 is a flowchart illustrating a flow of processing of the document management server.

### DETAILED DESCRIPTION

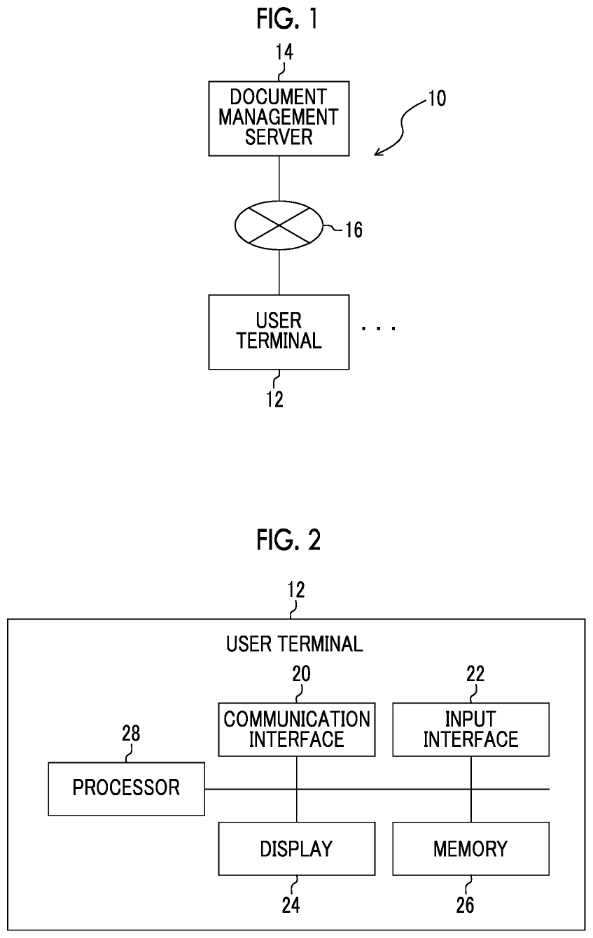

FIG. 1 is a schematic configuration diagram of an information processing system 10 according to the exemplary embodiment. The information processing system 10 is configured to include a user terminal 12 used by a user and a document management server 14 as an information processing apparatus. While only one user terminal 12 is illustrated in FIG. 1, a plurality of user terminals 12 used by a plurality of users may be included in the information processing system 10. The user terminal 12 and the document management server 14 are communicably connected to each other via a communication line 16 including, for example, an Internet line or a local area network (LAN). As will be described in detail later, the document management server 14 is an information processing apparatus that provides a button for inputting an instruction related to target data as an operator displayed on a display screen to the user who has accessed the document management server 14 using the user terminal 12.

In the exemplary embodiment, the document management server 14 is a server that provides a document management service to the user. That is, in the exemplary embodiment, the information processing system 10 is a document management system that manages an electronic document as the target data. The document management service is a service for managing an electronic document transmitted from the user and providing the managed electronic document to the user in response to a request from the user. In addition, in the document management service, each user can perform an operation (editing, storage, transmission, or the like) for the managed electronic document. Specifically, the document management server 14 provides a document management application for processing the managed electronic document to the user. In a case where the document management application is executed in the user terminal 12, the above button is displayed on an execution screen of the document management application.

The information processing apparatus included in the information processing system 10 is not limited to the document management server 14. That is, the information processing system 10 is not limited to the document management system. Any apparatus that can provide the button displayed on the display screen for inputting the instruction related to the target data to the user may be used as the information processing apparatus. For example, the information processing apparatus may be a server that manages image data or music data as the target data and provides the button displayed on the display screen for inputting the instruction related to the target data to the user.

FIG. 2 is a schematic configuration diagram of the user terminal 12. While the user terminal 12 is a tablet terminal, for example, a personal computer or a smartphone, any computer that performs functions described below may be used as the user terminal 12.

A communication interface 20 is configured to include, for example, a network adapter. The communication interface 20 performs a function of communicating with the document management server 14 via the communication line 16.

An input interface 22 is configured to include, for example, a touch panel, a button, a mouse, or a keyboard. The input interface 22 is used for inputting an instruction of the user into the user terminal 12.

A display 24 is configured to include, for example, a liquid crystal panel. Various display screens are displayed on the display 24. Particularly, the button provided from the document management server 14 and the display screen related to the document management service (both will be described in detail later) are displayed on the display 24.

A memory 26 is configured to include, for example, a hard disk drive (HDD), a solid state drive (SSD), an embedded multi media card (eMMC), a read only memory (ROM), or a random access memory (RAM). The document management application provided from the document management service (that is, the document management server 14) is installed in the memory 26.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The processor 28 controls each unit of the user terminal 12.

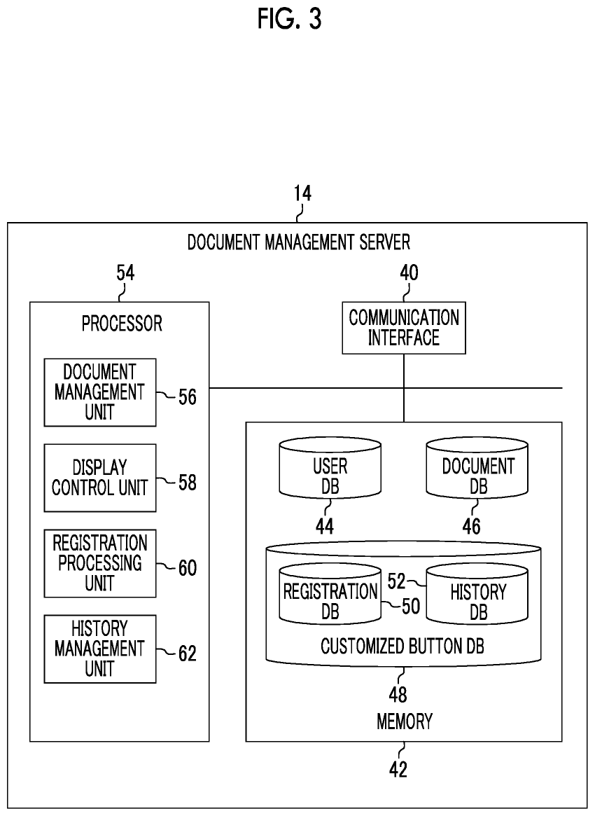

FIG. 3 is a schematic configuration diagram of the document management server 14. The document management server 14 is configured with, for example, a server computer. The document management server 14 may be configured with a plurality of computers. That is, functions performed by the document management server 14 described below may be implemented by cooperation among the plurality of computers.

A communication interface 40 is configured to include, for example, a network adapter. The communication interface performs a function of communicating with the user terminal 12 via the communication line 16.

A memory 42 is configured to include, for example, an HDD, an SSD, an eMMC, a ROM, or a RAM. The memory 42 stores an information processing program for functioning of each unit of the document management server 14. In addition, the memory 42 stores the document management application provided to the user. Furthermore, as illustrated in FIG. 3, the memory 42 stores a user data base (DB) 44, a document DB 46, and a customized button DB 48.

The user DB 44 stores information related to the user who has performed user registration for the document management service provided by the document management server 14. For example, the user DB 44 stores a user ID for uniquely identifying the user and authentication information (for example, a password) of the user in association with each other. In a case of processing the user registration, the information stored in the user DB 44 is transmitted to the document management server 14 from the user terminal 12 by the user.

The document DB 46 stores information related to the electronic document managed in the document management service. For example, the document DB 46 stores the electronic document, a document ID for uniquely identifying the electronic document, and information indicating a task space in which the electronic document is stored, in association with each other. For example, the electronic document stored in the document DB 46 is transmitted to the document management server 14 from the user terminal 12 by the user.

In the specification, the task space means a directory (or may be referred to as a folder) that is provided to the user in the document management service and is defined in the memory 42. In the memory 42, a task space structure (directory structure) used in the document management service can be defined, and the electronic document managed in the document management service can be stored at the defined task space. A task space name (directory name) or information such as a path indicating a location of the task space in the memory 42 is assigned to each task space. Accordingly, the task space can be uniquely identified.

The user can access each task space from the user terminal 12 and can perform a task for the electronic document stored in the task space. Task spaces may include a shared task space that can be accessed by a plurality of users at the same time, and in which the plurality of users perform the task in cooperation with each other. In the shared task space, the plurality of users can perform the task (document editing, document management, or the like) related to the electronic document in cooperation with each other. In addition, task spaces may include a personal task space that can be accessed by only a specific user.

A role can be defined in advance for each task space. For example, in a task space “invoice”, various invoices are stored, and a rule such that the user performs a task for each invoice by accessing the task space can be defined. In addition, for example, in a task space “first approval”, invoices transmitted from the task space “invoice” are stored, and a rule such that a first approver (for example, a department manager) performs a first approval task for each invoice by accessing the task space can be defined. Furthermore, for example, in a task space “final approval”, first-approved invoices transmitted from the task space “first approval” are stored, and a rule such that a final approver (for example, a director) performs a final approval task for each invoice by accessing the task space can be defined.

In addition, in the document management service, a series of tasks (referred to as a “workflow”) performed for one or a plurality of electronic documents in a plurality of task spaces may be able to be defined. This defined workflow is stored in the memory 42. Example of the workflow includes, as described above, a workflow including a first task step in which an invoice issuer performs the task for an electronic document “invoice” in the task space “invoice” and transmits the electronic document “invoice” to the task space “first approval”, a second task step in which the first approver performs the task for the electronic document “invoice” transmitted from the task space “invoice” and transmits the electronic document “invoice” to the task space “final approval”, and a third task step in which the final approver performs the task for the electronic document “invoice” transmitted from the task space “first approval” in the task space “final approval”. While the electronic document for which the task is performed is identical in each task step, the task for different electronic documents may be performed in each task step in the workflow.

As described above, in the exemplary embodiment, the “task step” means a step of performing the task related to a certain electronic document in a certain task space. Accordingly, in the exemplary embodiment, the “task step” is a concept including at least one of the electronic document or the task space.

The task space, the role of each task space, and the workflow may be able to be defined by the user.

The customized button DB 48 as an operator data base stores information related to a customized button. In the document management application, the user can input various instructions related to the electronic document. A plurality of buttons associated with each instruction are prepared in advance in the document management application. The user can input an intended instruction into the document management application by operating a button that is displayed on the display screen and corresponds to the instruction. Here, the customized button is a button that is customized for each user or task step, in other words, associated with the user or the task step, among buttons usable in the document management application. The customized button is a concept in contrast to a normal button that is constantly displayed on the display screen in the same manner regardless of the user and the task step (in other words, constantly displayed on the display screen in the same manner even in a case where anyone opens any electronic document in any task space in the document management application).

As illustrated in FIG. 3, the customized button DB 48 is configured to include a registration DB 50 and a history DB 52. Details of the customized button DB 48 will be described later together with processing of a processor 54 (particularly, a registration processing unit 60 and a history management unit 62).

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively.

The order of operations of the processor is not limited to one described in the embodiments above, and may be changed.

The processor 54 performs functions as a document management unit 56, a display control unit 58, the registration processing unit 60, and the history management unit 62 in accordance with the information processing program stored in the memory 42.

The document management unit 56 authenticates the user who has performed the user registration in advance, by authentication processing and then, provides the document management service to the authenticated user. Specifically, the document management unit 56 executes processing related to the electronic document (for example, editing of the electronic document, storage of the electronic document in each task space, or transmission of the electronic document to the user terminal 12) in accordance with an instruction from the user.

The display control unit 58 displays the display screen related to the document management service on the display 24 of the user terminal 12 used by the user who has accessed the document management service. Specifically, in a case where the user accesses the document management service and passes authentication, the display control unit 58 displays the display screen of the document management application on the display 24 of the user terminal 12.

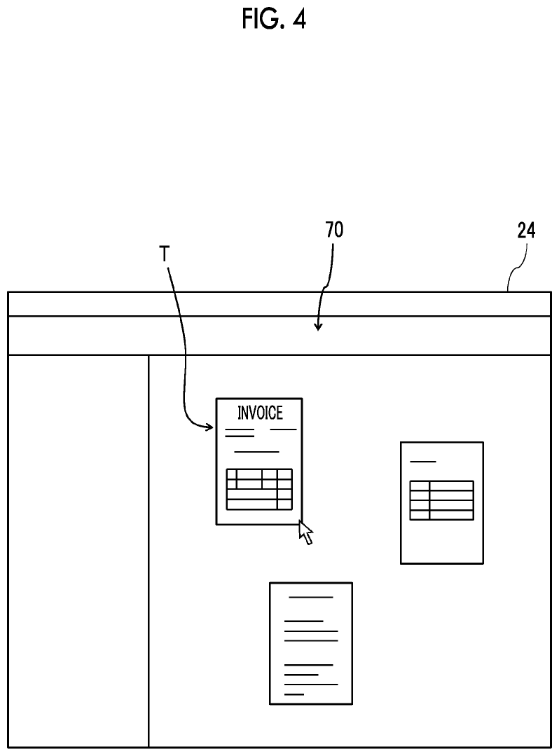

FIG. 4 is a diagram illustrating an example of the display screen of the document management application displayed on the display 24 of the user terminal 12 by the display control unit 58. In FIG. 4, an example of a document management window 70 that is displayed in a case where the user has accessed a certain task space is illustrated. A thumbnail T of the electronic document stored in the task space is displayed in the document management window 70. In a case where the user operates (double-clicks) an intended thumbnail T, the display control unit 58 displays an editing screen (described later) of the electronic document corresponding to the thumbnail T on the display 24.

In addition, the display control unit 58 displays the customized button on the display 24 of the user terminal 12 together with the editing screen of the electronic document. Display control processing of the customized button by the display control unit 58 will be described later.

The registration processing unit 60 registers a user-associated registration button as a part of a user-associated operator in accordance with the instruction from the user. The user-associated registration button is a customized button that is registered by the user and is associated with the user. The user can select one or a plurality of buttons corresponding to an instruction that can be input into the document management application, and register the button as the user-associated registration button. The invention is not limited thereto. For example, the user can register a button for inputting an instruction specific to the user as the user-associated registration button. For example, the instruction specific to the user is an instruction to attach a stamp having a name of the user to the electronic document. Alternatively, the user can register a button associated with an instruction frequently input by the user as the user-associated registration button. The registration processing unit 60 stores the user ID of the user and the user-associated registration button selected by the user in the registration DB 50 in association with each other.

In addition, the registration processing unit 60 registers a document-associated registration button as a part of a target data-associated operator in accordance with the instruction from the user. The document-associated registration button is a customized button that is registered by the user and is associated with a certain electronic document stored in the document DB 46. The user can select one or a plurality of buttons corresponding to the instruction that can be input into the document management application, and register the button as the document-associated registration button. The invention is not limited thereto. For example, the user can register, as the document-associated registration button, a button associated with an instruction that is considered to be frequently input for the electronic document by a plurality of users including the user. The registration processing unit 60 stores the document ID of the electronic document and the document-associated registration button selected by the user in the registration DB 50 in association with each other.

Furthermore, the registration processing unit 60 registers a task space-associated registration button as a part of a task space-associated operator in accordance with the instruction from the user. The task space-associated registration button is a customized button that is registered by the user and is associated with a certain task space defined in the document management service. The user can select one or a plurality of buttons corresponding to the instruction that can be input into the document management application, and register the button as the task space-associated registration button. The invention is not limited thereto. For example, the user can register a button for inputting an instruction having a content corresponding to the task performed in the task space as the task space-associated registration button. For example, in a case where a workflow of transmitting the electronic document from the task space “invoice” to the task space “first approval” is defined, a button for transmission to the task space “first approval” can be registered in the task space “invoice” as the task space-associated registration button. Alternatively, the user can register, as the task space-associated registration button, a button associated with an instruction that is considered to be frequently input in the task space by the plurality of users including the user. The registration processing unit 60 stores the information (for example, the task space name or the path) for uniquely identifying the task space and the task space-associated registration button selected by the user in the registration DB 50 in association with each other.

As described above, in the exemplary embodiment, the “task step” is a concept including at least one of the electronic document or the task space. Thus, at least one of the document-associated registration button as the target data-associated operator or the task space-associated registration button as the task space-associated operator corresponds to a task step-associated operator.

As a method of registering the user-associated registration button, the document-associated registration button, and the task space-associated registration button (collectively referred to as the “registration button”), for example, the user can use a button registration window provided by the document management application. In the button registration window, an instruction content (may be referred to as a command) that can be input into the document management application can be selected, and registration of a button corresponding to the selected instruction content as any of the user-associated registration button, the document-associated registration button, and the task space-associated registration button can be selected. By selecting the instruction content and a type of button to be registered, the user can register a button corresponding to an intended instruction content as any of the user-associated registration button, the document-associated registration button, and the task space-associated registration button.

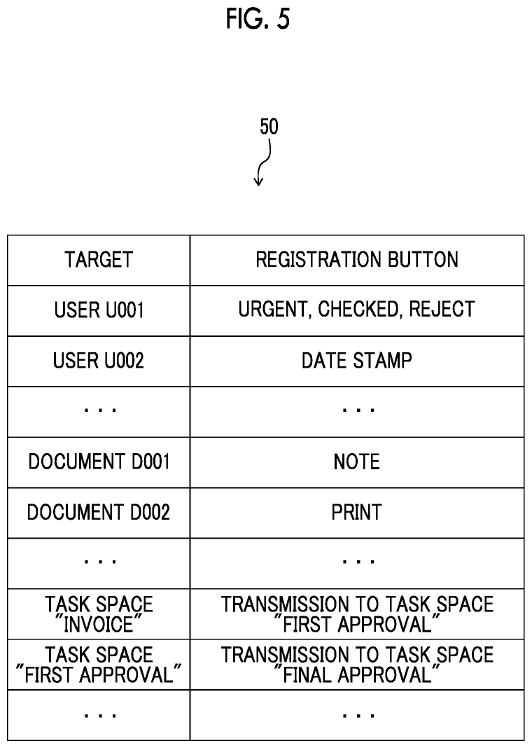

By doing so, the registration button can be registered for each user and each task step (that is, each electronic document or each task space). FIG. 5 is a conceptual diagram illustrating an example of a content of the registration DB 50. Among the registration buttons illustrated in FIG. 5, a button associated with a user indicated by “user U001” or “user U002” is the user-associated registration button. A button associated with an electronic document indicated by “document D001” or “document D002” is the document-associated registration button. A button associated with a task space indicated by “task space “invoice”” or “task space “first approval”” is the task space-associated registration button.

The history management unit 62 registers, in the history DB 52, a use history of buttons (including the normal button and the customized button) that are used in the past in the document management service by the user. Particularly, the history management unit 62 registers the use history of buttons separately for each user and each task step (that is, each electronic document or each task space).

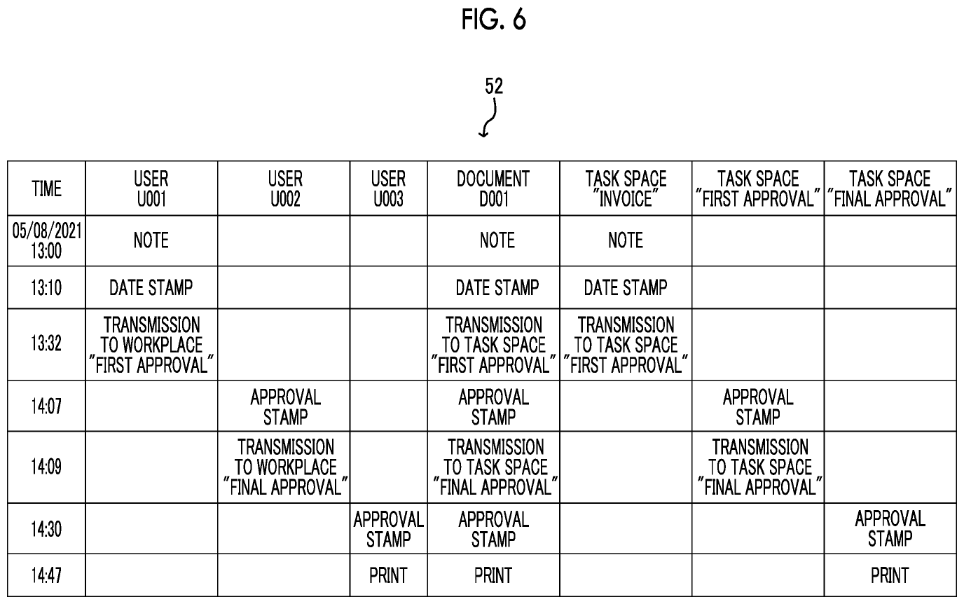

FIG. 6 is a conceptual diagram illustrating a content of the history DB 52. As illustrated in FIG. 6, a used time of a button and the used button are recorded for each user, each document, and each task space in the history DB 52. The content shown by the history DB 52 illustrated in FIG. 6 indicates that in the task space “invoice”, the user U001 uses, as a task for the document D001, each of a note button for attaching a note to the electronic document at 13:00 on May 18, 2021, a date stamp button for attaching a date stamp to the electronic document at 13:10, and the button for transmission to the task space “first approval” for transmitting the electronic document to the task space “first approval” at 13:32. In addition, the content indicates that in the task space “first approval”, then, the user U002 uses, as the task for the document D001, each of an approval stamp button for attaching an approval stamp to the electronic document at 14:07 and a button for transmission to the task space “final approval” for transmitting the electronic document to the task space “final approval” at 14:09. Furthermore, the content indicates that in the task space “final approval”, then, the user U003 uses, as the task for the document D001, each of the approval stamp button at 14:30 and a print button for printing the electronic document at 14:47.

The history DB 52 is used as indicating a user-associated history button as a part of the user-associated operator. The user-associated history button is a customized button that is registered by the history management unit 62 and is associated with the user. For example, in the example in FIG. 6, the note button, the date stamp button, and the button for transmission to the task space “first approval” can be set as the user-associated history button associated with the user U001. The approval stamp button and the button for transmission to the task space “final approval” can be set as the user-associated history button associated with the user U002. The approval stamp button and the print button can be set as the user-associated history button associated with the user U003.

In addition, the history DB 52 is used as indicating a document-associated history button as a part of the target data-associated operator. The document-associated history button is a customized button that is registered by the history management unit 62 and is associated with the electronic document. For example, in the example in FIG. 6, the note button, the date stamp button, the button for transmission to the task space “first approval”, the approval stamp button, the button for transmission to the task space “final approval”, and the print button can be set as the document-associated history button associated with the document D001.

Furthermore, the history DB 52 is used as indicating a task space-associated history button as a part of the task space-associated operator. The task space-associated history button is a customized button that is registered by the history management unit 62 and is associated with the task space. For example, in the example in FIG. 6, the note button, the date stamp button, and the button for transmission to the task space “first approval” can be set as the task space-associated history button associated with the task space “invoice”. The approval stamp button and the button for transmission to the task space “final approval” can be set as the task space-associated history button associated with the task space “first approval”. The approval stamp button and the print button can be set as the task space-associated history button associated with the task space “final approval”.

As described above, in the exemplary embodiment, the “task step” is a concept including at least one of the electronic document or the task space. Thus, at least one of the document-associated history button as the target data-associated operator or the task space-associated history button as the task space-associated operator corresponds to the task step-associated operator.

All buttons registered in the history DB 52 may not necessarily be the user-associated history button, the document-associated history button, and the task space-associated history button (collectively referred to as the “history button”). For example, the user-associated history button of the user may be decided in accordance with the number of uses of a button used in the past by a specific user. A method of deciding the history button based on the history DB 52 will be described later.

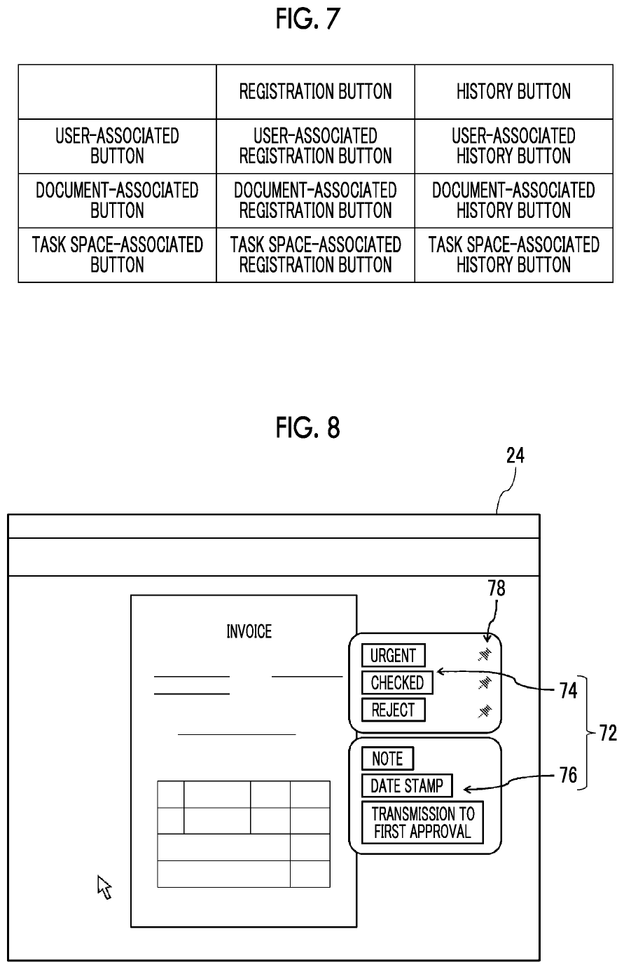

In the following description, a concept including the user-associated registration button and the user-associated history button will be referred to as a user-associated button. A concept including the document-associated registration button and the document-associated history button will be referred to as a document-associated button. A concept including the task space-associated registration button and the task space-associated history button will be referred to as a task space-associated button. A relationship between titles of each customized button is summarized in FIG. 7.

Hereinafter, details of the display control processing of the customized button by the display control unit 58 will be described with reference to FIG. 8 to FIG. 14. In the following description, an assumption that the content illustrated in FIG. 5 is registered in the registration DB 50, and the content illustrated in FIG. 6 is registered in the history DB 52 is made.

In a case where the user who logs in to the document management service operates the thumbnail T in the document management window 70 (refer to FIG. 4), the display control unit 58 displays an editing screen of the electronic document on the display 24 of the user terminal 12 of the user. Here, an assumption that the user is the user U001 illustrated in FIG. 5 and FIG. 6, the electronic document is the document D002 illustrated in FIG. 5, and the task space in which the task for the electronic document is performed is the task space “invoice” illustrated in FIG. 5 and FIG. 6 is made.

FIG. 8 is a diagram illustrating a state where the customized button is displayed on the editing screen of the electronic document. The display control unit 58 displays the editing screen of the electronic document and also displays the customized button on the display screen on the display 24 of the user terminal 12 by referring to the customized button DB 48.

Here, while the customized button includes various buttons as illustrated in FIG. 7, which button is to be displayed as a default display (that is, a display in a case where the editing screen of the electronic document is opened) can be set in advance by the user. The example in FIG. 8 is an example in a case where the user-associated button is set as default display setting. By referring to the default display setting, the display control unit 58 selects the user-associated button based on the customized button DB 48 and displays a selected user-associated button 72, particularly, a user-associated registration button 74 and a user-associated history button 76, on the display screen.

Specifically, the display control unit 58 specifies the user ID of the user based on login information of the user and then, refers to the registration DB 50 and selects the user-associated registration button 74 associated with the specified user ID. Here, with reference to FIG. 5, an urgent button, a checked button, and a reject button associated with the user U001 in the registration DB 50 are selected. In addition, the display control unit 58 refers to the history DB 52 and selects the user-associated history button 76 associated with the specified user ID. Here, with reference to FIG. 6, the note button, the date stamp button, and the button for transmission to the task space “first approval” associated with the user U001 in the history DB 52 are selected. The selected user-associated registration button 74 and the user-associated history button 76 are displayed on the display screen.

In the example in FIG. 8, the display control unit 58 displays both of the user-associated registration button 74 and the user-associated history button 76 as the user-associated button 72. However, only one may be displayed. In addition, the display control unit 58 may switch between displaying any of the user-associated registration button 74 and the user-associated history button 76 and displaying both in accordance with the instruction of the user.

In the example in FIG. 8, the display control unit 58 displays the user-associated button 72 as the default display. However, depending on the default display setting, the display control unit 58 may select and display the document-associated button (at least one of the document-associated registration button or the document-associated history button) or the task space-associated button (at least one of the task space-associated registration button or the task space-associated history button) based on the customized button DB 48.

The display control unit 58 displays a pinning icon 78 near each registration button (in the example in FIG. 8, each user-associated registration button 74). The pinning icon 78 is an icon meaning that a nearby button is the registration button. By the pinning icon 78, the user can perceive that the button is the registration button.

While the history button is decided based on the history DB 52, as described above, the method of deciding the history button based on the history DB 52 may employ several methods. Here, various methods of deciding the history button based on the history DB 52 will be described.

A first method is a method in which the display control unit 58 sets all buttons that are registered in the history DB 52 and are used in the past by the user as the user-associated history button 76.

Similarly, the display control unit 58 can set all buttons that are registered in the history DB 52 and are used in the past for the electronic document as the document-associated history button, and can set all buttons used in the past in the task space as the task space-associated history button.

A second method is a method in which based on the used time of the button registered in the history DB 52, the display control unit 58 sets a predetermined number of buttons dating back from the current point in time or a button used by the user within a predetermined time period dating back from the current point in time as the user-associated history button 76 among buttons used in the past by the user.

Similarly, the display control unit 58 can set a predetermined number of buttons dating back from the current point in time or a button used for the electronic document within a predetermined time period dating back from the current point in time as the document-associated history button among buttons used in the past for the electronic document, and set a predetermined number of buttons dating back from the current point in time or a button used in the task space within a predetermined time period dating back from the current point in time as the task space-associated history button among buttons used in the past for the task space.

A third method is a method in which the display control unit 58 decides the user-associated history button 76 based on the number of uses of the user for each button used in the past by the user. Specifically, the display control unit 58 sets a button that is used a large number of times in the past by the user as the user-associated history button 76. For example, the display control unit 58 sets a predetermined number of buttons in descending order from the button having the largest number of uses of the user in the past or a button used a predetermined number of times or more in the past by the user as the user-associated history button 76.

Similarly, the display control unit 58 can decide the document-associated history button based on the number of uses for each button used in the past for the electronic document, and decide the task space-associated history button based on the number of uses of each button used in the past in the task space.

A fourth method is a method in which the display control unit 58 sets a series of buttons that are used in order in the past by the user as the user-associated history button 76. For example, in a case where the user uses a plurality of specific buttons in the past many times in a specific order, the display control unit 58 can set the plurality of buttons as the user-associated history button 76. Specifically, the display control unit 58 analyzes use patterns of buttons of the user in the past based on the history DB 52 and sets a series of buttons included in a use pattern having the highest frequency of use (specifically, occurring a predetermined number of times or more) as the user-associated history button 76. For example, in a case where a frequency of use in order of note button→date stamp button→button for transmission to task space “first approval” in the past by a certain user is high, the note button, the date stamp button, and the button for transmission to the task space “first approval” can be set as the user-associated history button 76 of the user.

Similarly, the display control unit 58 can set a series of buttons that are used in order in the past for the electronic document as the document-associated history button, and can set a series of buttons used in order in the past in the task space as the task space-associated history button.

A fifth method is a method in which the display control unit 58 maintains a button that is immediately previously used by the user, and sets, as the user-associated history button 76, a button subsequent to the button immediately previously used by the user in order of use of a series of buttons that are obtained from the history DB 52 and are used in order in the past by the user. For example, in a case where the frequency of use in order of note button→date stamp button→button for transmission to task space “first approval” in the past by a certain user is high, and the user immediately previously uses the date stamp button, the button for transmission to the task space “first approval” can be set as the user-associated history button 76 of the user.

Similarly, the display control unit 58 can maintain a button that is immediately previously used for the electronic document, and set, as the document-associated history button, a button subsequent to the button immediately previously used for the electronic document in order of use of a series of buttons that are obtained from the history DB 52 and are used in order in the past for the electronic document. In addition, the display control unit 58 can maintain a button that is immediately previously used in the task space, and set, as the task space-associated history button, a button subsequent to the button immediately previously used in the task space in order of use of a series of buttons that are obtained from the history DB 52 and are used in order in the past in the task space.

In a case of employing the first method, the number of buttons displayed as the history button is increased, and the display screen may be complicated. In this case, a button having a high possibility of use by the user can be selected and displayed as the history button by employing the second to fifth methods. Accordingly, complication of the display screen may be suppressed. Any of the methods to be employed as the method of deciding the history button may be decided in advance by a manager or the like of the document management server 14, or may be able to be changed by the user.

In addition, the display control unit 58 may decide the user-associated history button, the document-associated history button, and the task space-associated history button in accordance with a content of an instruction associated with each customized button registered in the history DB 52.

For example, a date stamp or an approval stamp assigned to the electronic document by operating the date stamp button or the approval stamp button may include personal information (a name, a job position, and the like) of the user. In a case where the button for inputting the instruction specific to the user is displayed as the document-associated history button or the task space-associated history button, other users can input the instruction specific to the user. Accordingly, even in a case where the date stamp button or the approval stamp button is associated with the electronic document or the task space in the history DB 52, the display control unit 58 may not include, for example, the date stamp button or the approval stamp button in the document-associated history button and the task space-associated history button. In other words, for example, the button for inputting the instruction specific to the user may be included in only the user-associated history button.

In addition, for example, in a workflow of performing the task in the task space “invoice” and then, transmitting the electronic document related to the task to the task space “first approval”, the button for transmission to the task space “first approval” is meaningful in a case where the button for transmission to the task space “first approval” is displayed to the user performing the task in the task space “invoice”, and is not meaningful in a case where the button for transmission to the task space “first approval” is displayed to the user performing the task in the task space “first approval”. That is, in this case, the button for transmission to the task space “first approval” is said to be a button for inputting an instruction having a content corresponding to the task performed in the task space “invoice”. In this case, even in a case where the button for transmission to the task space “first approval” is associated with the user or the electronic document in the history DB 52, the display control unit 58 may not include, for example, the button for transmission to the task space “first approval” in the user-associated history button and the document-associated history button. In other words, for example, a button for inputting an instruction having a content corresponding to a task performed in a certain task space may be included in only the task space-associated history button. In still other words, for example, a button for inputting an instruction specific to a certain task space may be included in only the task space-associated history button.

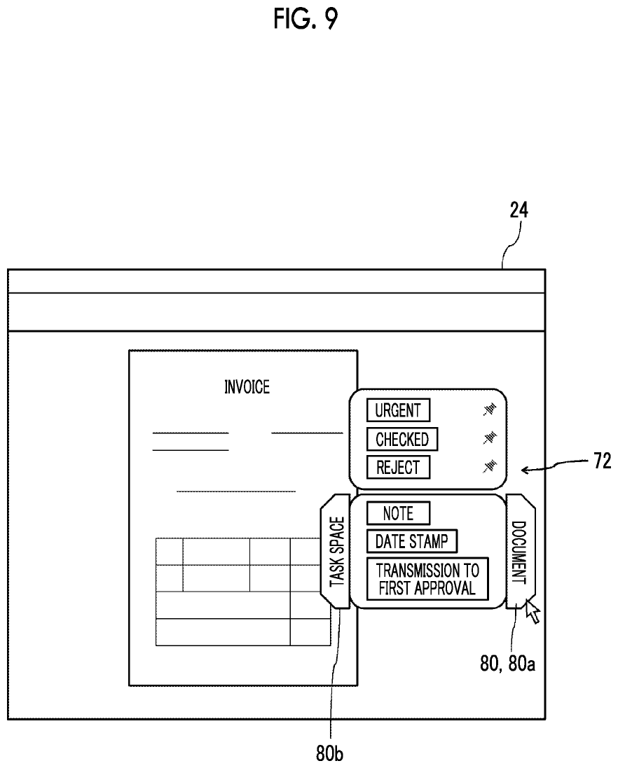

The display control unit 58 may select the customized button to be displayed on the display screen in accordance with the instruction from the user. For example, as illustrated in FIG. 9, in a case where the user-associated button 72 is displayed, the display control unit 58 displays, on the display screen, a switching button 80 for switching the customized button displayed on the display screen among the user-associated button 72, the document-associated button, and the task space-associated button. In the example in FIG. 9, a switching button 80a for displaying the document-associated button and a switching button 80b for displaying the task space-associated button are displayed as the switching button 80.

In a case where the user operates the switching button 80a in FIG. 9, an instruction to display the document-associated button is transmitted to the document management server 14 from the user terminal 12. In accordance with the instruction from the user, the display control unit 58 specifies the document ID (here, the document D002 as described above) of the electronic document currently displayed on the editing screen and then, refers to the registration DB 50 and selects the document-associated registration button associated with the specified document ID. With reference to FIG. 5, here, the print button associated with the document D002 in the registration DB 50 is selected. In addition, the display control unit 58 refers to the history DB 52 and selects the document-associated history button associated with the specified document ID. While a history related to the document D002 is not illustrated in FIG. 6, here, an assumption that a “subsequent step” button and a difference extraction button are selected is made. The display control unit 58 displays the selected document-associated registration button and document-associated history button on the display screen instead of the user-associated button 72.

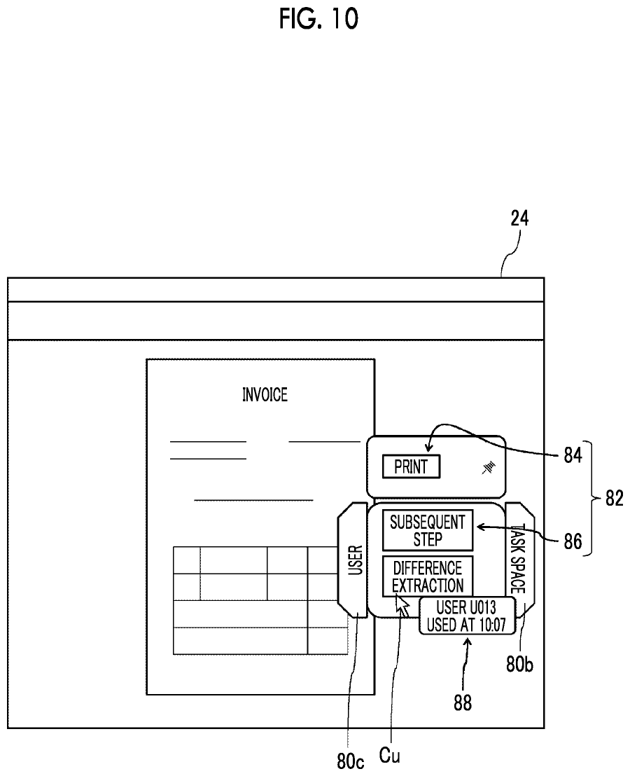

FIG. 10 is a diagram illustrating a state where a document-associated button 82 is displayed on the display screen. Here, the display control unit 58 displays both of a document-associated registration button 84 and a document-associated history button 86 as the document-associated button 82. However, only one may be displayed. In addition, in a case where the switching button 80a (refer to FIG. 9) is operated, the display control unit 58 may continue displaying the user-associated registration button 74 and display the document-associated history button 86 instead of the user-associated history button 76. In this case, a combination of the user-associated registration button 74 and the document-associated history button 86 is displayed on the display screen.

In a case where the document-associated history button 86 (or the task space-associated history button) is displayed as the history button, for example, the display control unit 58 may display, on the display screen, information indicating a user who uses the history button in the past. For example, as illustrated in FIG. 10, in a case where the user moves a cursor Cu to the difference extraction button that is the document-associated history button 86, the display control unit 58 displays, on the display screen, a tooltip 88 including the user ID (or a user name) of the user who uses the difference extraction button in the past for the document, and the used time of the user.

In a case where the user operates the switching button 80b in FIG. 10, an instruction to display the task space-associated button is transmitted to the document management server 14 from the user terminal 12. In accordance with the instruction from the user, the display control unit 58 specifies the task space (here, the task space “invoice” as described above) currently accessed by the user and then, refers to the registration DB 50 and selects the task space-associated registration button associated with the specified task space. With reference to FIG. 5, here, the button for transmission to the task space “first approval” associated with the task space “invoice” in the registration DB 50 is selected. In addition, the display control unit 58 refers to the history DB 52 and selects the task space-associated history button associated with the specified task space. Here, with reference to FIG. 6, the note button, the date stamp button, and the button for transmission to the task space “first approval” associated with the specified task space in the history DB 52 are selected. The display control unit 58 displays the selected task space-associated registration button and task space-associated history button on the display screen instead of the document-associated button 82.

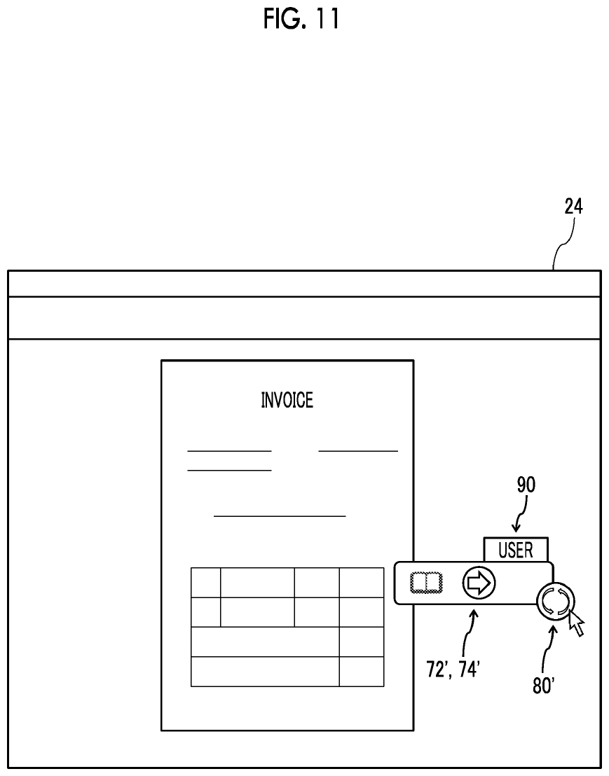

FIG. 11 is a diagram illustrating a display example of a user-associated button 72′ and a switching button 80′ according to a modification example. In the example in FIG. 11, only a user-associated registration button 74′ is illustrated as the user-associated button 72′. The switching button 80′ is displayed aside the user-associated button 72′. Each time the user operates the switching button 80′, the display control unit 58 switches the displayed customized button in order of document-associated button→task space-associated button→user-associated button. In addition, for example, a tab 90 that indicates a type of currently displayed customized button may be displayed together. Accordingly, the user can perceive the type of currently displayed customized button.

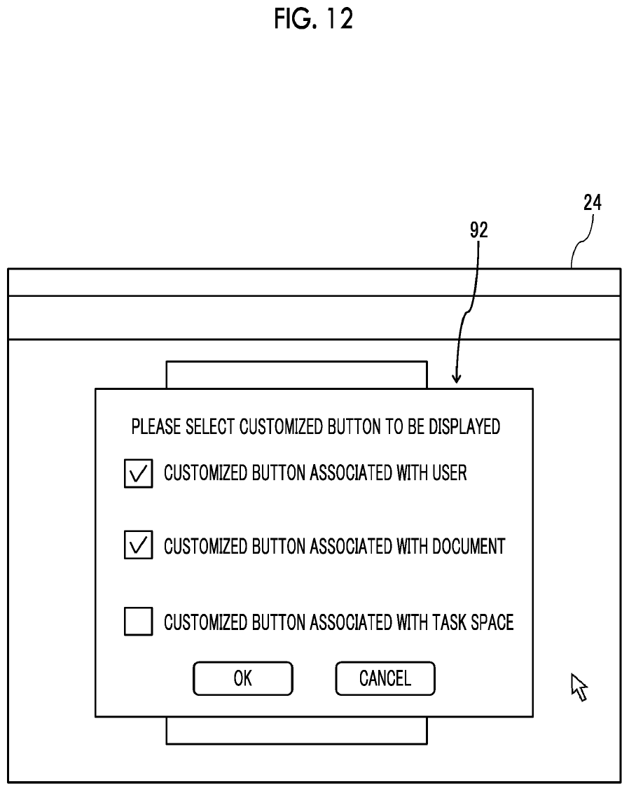

FIG. 12 is a diagram illustrating a display example of a button switching window 92. The display control unit 58 may display, instead of or in addition to the switching button 80, the button switching window 92 illustrated in FIG. 12 on the display screen in accordance with the instruction of the user. In the button switching window 92, the user can select the customized button to be displayed on the display screen. In the example in FIG. 12, a checkbox associated with each of the user-associated button, the document-associated button, and the task space-associated button is disposed in the button switching window 92, and the user can select the customized button to be displayed by checking an intended checkbox.

According to a selection method using the button switching window 92, the user can select a plurality of customized buttons to be displayed from the user-associated button, the document-associated button, and the task space-associated button. For example, the user-associated button and the document-associated button can be selected.

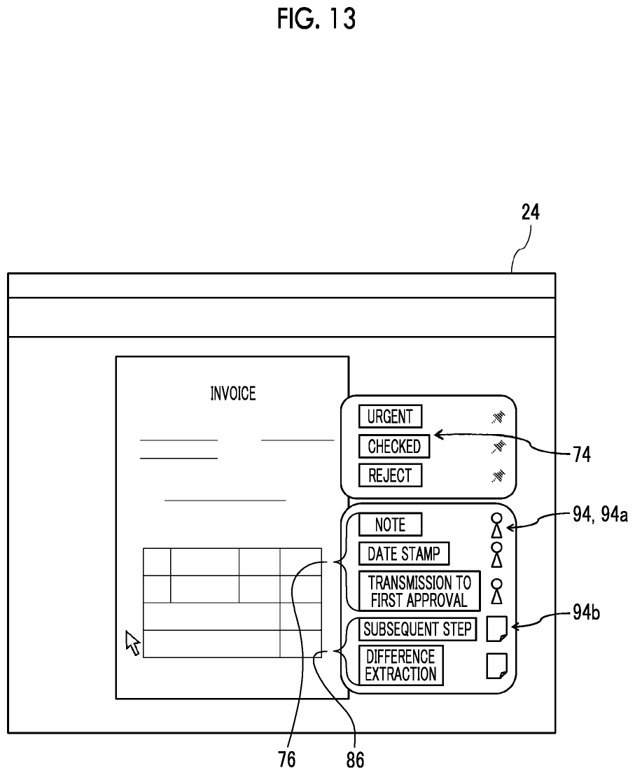

FIG. 13 is a diagram illustrating a display example in which the user-associated history button 76 and the document-associated history button 86 are displayed at the same time. In a case where the user selects the user-associated button and the document-associated button in the button switching window 92, as illustrated in FIG. 13, the display control unit 58 displays the user-associated button and the document-associated button on the display screen at the same time. In the example in FIG. 13, the user-associated registration button 74, the user-associated history button 76, and the document-associated history button 86 are displayed. The document-associated registration button 84 (refer to FIG. 10) may be additionally displayed, or only the user-associated history button 76 and the document-associated history button 86 may be displayed.

In a case where a plurality of buttons are displayed on the display screen from the user-associated button, the document-associated button, and the task space-associated button, the display control unit 58 may display, for example, the user-associated button, the document-associated button, and the task space-associated button on the display screen in display forms identifiable from each other. In the example in FIG. 13, the display control unit 58 displays the user-associated history button 76 and the document-associated history button 86 to be identifiable by displaying an identification icon 94. Specifically, the display control unit 58 displays an identification icon 94a having a shape of the user near the user-associated history button 76 and displays an identification icon 94b having a shape of the document near the document-associated history button 86.

In a case where the history button is displayed on the display screen, the registration processing unit 60 may register the history button displayed on the display screen as the registration button in accordance with an operation of the user performed on the display screen.

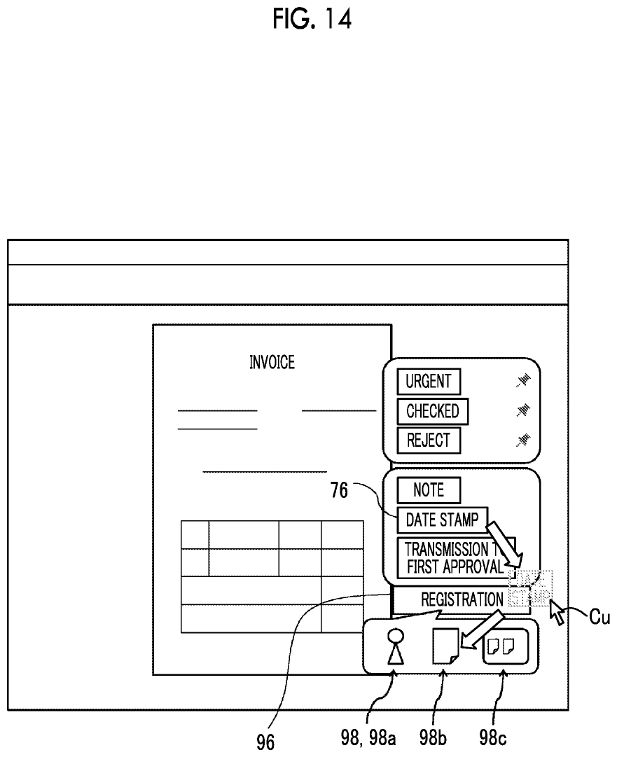

For example, as illustrated in FIG. 14, a case where the user-associated history button 76 is displayed on the display screen is considered. In this case, the registration processing unit 60 registers the user-associated history button 76 as the user-associated registration button, the document-associated registration button, or the task space-associated registration button in accordance with the operation of the user performed on the display screen. In a case where the document-associated history button is displayed on the display screen, the registration processing unit 60 registers the document-associated history button as the user-associated registration button, the document-associated registration button, or the task space-associated registration button in accordance with the operation of the user performed on the display screen. In addition, in a case where the task space-associated history button is displayed on the display screen, the registration processing unit 60 registers the task space-associated history button as the user-associated registration button, the document-associated registration button, or the task space-associated registration button in accordance with the operation of the user performed on the display screen.

The operation of the user performed on the display screen for registering the history button as the registration button may be any operation and, for example, may be an operation of dragging and dropping the registration button to a specific region on the display screen.

For example, in the example in FIG. 14, the display control unit 58 displays a registration button 96 on the display screen together with the user-associated history button 76. In a case where the user operates the registration button 96, the display control unit 58 displays an icon 98 as the specific region corresponding to the user-associated registration button, the document-associated registration button, and the task space-associated registration button on the display screen. Specifically, an icon 98a corresponding to the user-associated registration button, an icon 98b corresponding to the document-associated registration button, and an icon 98c corresponding to the task space-associated registration button are displayed.

Then, in a case where the user drags and drops the intended user-associated history button 76 (in the example in FIG. 14, the date stamp button) to the intended icon 98 on the display screen using the cursor Cu, the registration processing unit 60 registers the user-associated history button 76 in the registration DB 50 as the registration button.

For example, in a case where the user drags and drops the date stamp button as the user-associated history button 76 to the icon 90a, the registration processing unit 60 registers the date stamp button as the user-associated registration button of the user. In addition, for example, in a case where the user drags and drops the date stamp button as the user-associated history button 76 to the icon 90b, the registration processing unit 60 registers the date stamp button as the document-associated registration button of the electronic document currently displayed on the editing screen. In addition, for example, in a case where the user drags and drops the date stamp button as the user-associated history button 76 to the icon 90c, the registration processing unit 60 registers the date stamp button as the task space-associated registration button of the task space accessed by the user.

Even in a case where the document-associated history button or the task space-associated history button is displayed, in the same manner as described above, the registration processing unit 60 registers the document-associated history button or the task space-associated history button as the user-associated registration button, the document-associated registration button, or the task space-associated registration button by causing the user to drag and drop the document-associated history button or the task space-associated history button to the icon 98.

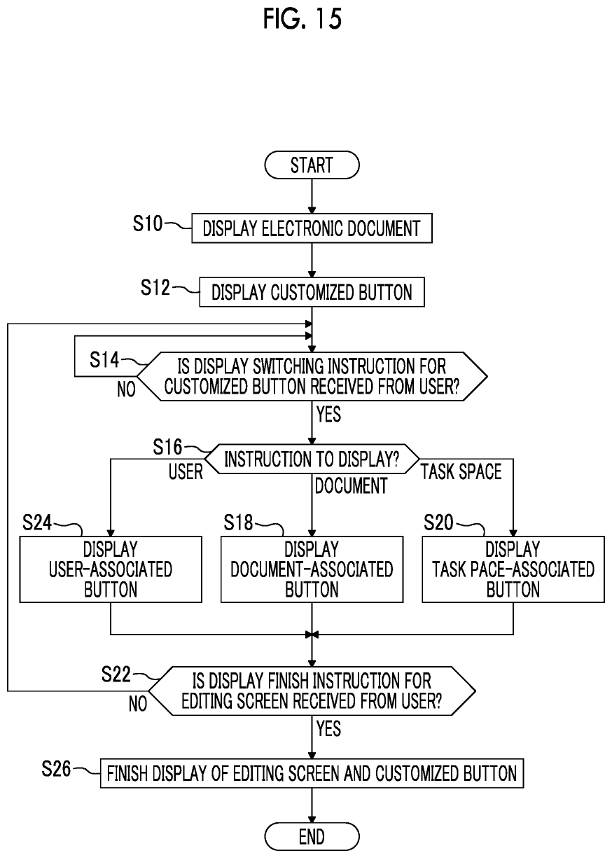

The above is a summary of the information processing system 10 according to the exemplary embodiment. Hereinafter, a flow of processing of the document management server 14 will be described in accordance with the flowchart illustrated in FIG. 15.

In step S10, in a case where the user who logs in to the document management service operates the thumbnail T in the document management window 70 (refer to FIG. 4), the display control unit 58 displays the editing screen of the electronic document on the display 24 of the user terminal 12 of the user.

In step S12, the display control unit 58 displays the customized button selected from the customized button DB 48 on the display screen by referring to the default display setting. Here, an assumption that the user-associated button is displayed is made.

In step S14, the display control unit 58 determines whether or not a display switching instruction for the customized button is received from the user. For example, the display control unit 58 determines whether or not the switching buttons 80 and 80′ (refer to FIGS. 9 to 11) are operated, or whether or not the display switching instruction is issued from the user by performing an operation on the button switching window 92 (refer to FIG. 12). In a case where the display switching instruction from the user is not issued, the display control unit 58 continues displaying the customized button (in the example, the user-associated button) displayed in step S12. In a case where the display switching instruction from the user is issued, a transition is made to step S16.

In step S16, the display control unit 58 determines which type of customized button to be displayed is indicated by the instruction received from the user.

In a case where the instruction to display the document-associated button is received from the user, a transition is made to step S18, and the display control unit 58 displays the document-associated button on the display screen instead of the user-associated button. In a case where the instruction to display the task space-associated button is received from the user, a transition is made to step S20, and the display control unit 58 displays the task space-associated button on the display screen instead of the user-associated button. Here, an assumption that the instruction to display the document-associated button is received from the user, and the display control unit 58 displays the document-associated button on the display screen instead of the user-associated button in step S18 is made.

In step S22, the display control unit 58 determines whether or not a display finish instruction for the editing screen of the electronic document is received from the user. In a case where the display finish instruction is not received, a return is made to step S14. In a case where the display switching instruction from the user is issued in step S14 again, and the instruction to display the user-associated button is received from the user in step S16 again, a transition is made to step S24. In step S24, the display control unit 58 displays the user-associated button again on the display screen instead of the document-associated button. Then, in a case where the display finish instruction is received in step S22, a transition is made to step S26.

In step S26, the display control unit 58 finishes the display of the editing screen of the electronic document and the customized button.

While the exemplary embodiment according to the exemplary embodiment of the invention is described above, the invention is not limited to the exemplary embodiment and can be subjected to various modifications without departing from a gist of the invention.

For example, in the exemplary embodiment, while the user DB 44, the document DB 46, and the customized button DB 48 are stored in the memory 42 of the document management server 14, these DBs may be stored in a memory of another apparatus accessible from the document management server 14.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
select at least one of a user-associated operator that is an operator for inputting an instruction related to target data and is associated with a user, or a task step-associated operator that is an operator for inputting the instruction related to the target data and is associated with a task step related to a task performed by one or a plurality of users, based on an operator database storing the user-associated operator and the task step-associated operator and display the selected operator on a display screen.

2. The information processing apparatus according to claim 1, wherein the processor is configured to:
select at least one of the user-associated operator or the task step-associated operator in accordance with an instruction from the user.

3. The information processing apparatus according to claim 1,
wherein the task step-associated operator includes at least one of a target data-associated operator that is an operator associated with the target data, or a task space-associated operator that is an operator associated with a task space which is a region on a memory storing the target data.

4. The information processing apparatus according to claim 2,
wherein the task step-associated operator includes at least one of a target data-associated operator that is an operator associated with the target data, or a task space-associated operator that is an operator associated with a task space which is a region on a memory storing the target data.

5. The information processing apparatus according to claim 3,
wherein a plurality of the task spaces in which tasks different from each other are performed are disposed, and
the task space-associated operator is an operator for inputting an instruction having a content corresponding to the task performed in the task space associated with the task space-associated operator.

6. The information processing apparatus according to claim 4,
wherein a plurality of the task spaces in which tasks different from each other are performed are disposed, and
the task space-associated operator is an operator for inputting an instruction having a content corresponding to the task performed in the task space associated with the task space-associated operator.

7. The information processing apparatus according to claim 1,
wherein the user-associated operator includes a user-associated history operator that is decided based on an operator use history of the user corresponding to the user-associated operator, and
the task step-associated operator includes a task step-associated history operator that is decided based on an operator use history in the task step corresponding to the task step-associated operator.

8. The information processing apparatus according to claim 2,
wherein the user-associated operator includes a user-associated history operator that is decided based on an operator use history of the user corresponding to the user-associated operator, and
the task step-associated operator includes a task step-associated history operator that is decided based on an operator use history in the task step corresponding to the task step-associated operator.

9. The information processing apparatus according to claim 7,
wherein the user-associated history operator is an operator that is decided based on the number of operator uses of the user, and
the task step-associated history operator is an operator that is decided based on the number of operator uses in the task step.

10. The information processing apparatus according to claim 7,
wherein the user-associated history operator includes a series of operators used in order by the user, and
the task step-associated history operator includes a series of operators used in order in the task step.

11. The information processing apparatus according to claim 10,
wherein the user-associated history operator is an operator subsequent to an operator immediately previously used by the user in order of use of the series of operators used in order by the user, and
the task step-associated history operator is an operator subsequent to an operator immediately previously used in the task step in order of use of the series of operators used in order in the task step.

12. The information processing apparatus according to claim 7, wherein the processor is configured to:
display information indicating a user who uses the task step-associated history operator in the past, on the display screen together with the task step-associated history operator.

13. The information processing apparatus according to claim 7,
wherein the user-associated operator includes a user-associated registration operator that is registered by the user corresponding to the user-associated operator,
the task step-associated operator includes a task step-associated registration operator that is registered by the user performing the task in the task step corresponding to the task step-associated operator, and
the processor is configured to:
display at least one between both of the user-associated registration operator and the user-associated history operator, and both of the task step-associated registration operator and the task step-associated history operator on the display screen.

14. The information processing apparatus according to claim 13, wherein the processor is configured to:
execute at least one of registering the user-associated history operator displayed on the display screen as the user-associated registration operator or the task step-associated registration operator in accordance with an operation of the user performed on the display screen, or registering the task step-associated history operator displayed on the display screen as the user-associated registration operator or the task step-associated registration operator in accordance with the operation of the user performed on the display screen.

15. The information processing apparatus according to claim 14,
wherein the operation of the user performed on the display screen is an operation of dragging and dropping the user-associated history operator or the task step-associated history operator to a specific region on the display screen.

16. The information processing apparatus according to claim 1, wherein the processor is configured to:
display, on the display screen, a switching operator for switching an operator displayed on the display screen between the user-associated operator and the task step-associated operator.

17. The information processing apparatus according to claim 1, wherein the processor is configured to:
display the user-associated operator and the task step-associated operator on the display screen in display forms identifiable from each other.

18. The information processing apparatus according to claim 1,
wherein the user-associated operator is an operator for inputting an instruction specific to the user corresponding to the user-associated operator.

19. A non-transitory computer readable medium storing an information processing program causing a computer to execute a process comprising:
selecting at least one of a user-associated operator that is an operator for inputting an instruction related to target data and is associated with a user, or a task step-associated operator that is an operator for inputting the instruction related to the target data and is associated with a task step in which a task related to the target data is performed by one or a plurality of users, based on an operator database storing the user-associated operator and the task step-associated operator and displaying the selected operator on a display screen.

20. An information processing method comprising:
selecting at least one of a user-associated operator that is an operator for inputting an instruction related to target data and is associated with a user, or a task step-associated operator that is an operator for inputting the instruction related to the target data and is associated with a task step related to a task performed by one or a plurality of users, based on an operator database storing the user-associated operator and the task step-associated operator and displaying the selected operator on a display screen.
